(19) United States
(12) Patent Application Publication
(10) Pub. No.: US 2017/0142196 A1
(43) Pub. Date: May 18, 2017

(54) METHOD AND APPARATUS FOR SELECTING SOURCE SERVER

(71) Applicants: Le Holdings (Beijing) Co., Ltd., Beijing (CN); LeCloud Computing Co., Ltd., Beijing (CN)

(72) Inventor: Guoliang SUN, Beijing (CN)

(21) Appl. No.: 15/245,344

(22) Filed: Aug. 24, 2016

Related U.S. Application Data
(63) Continuation of application No. PCT/CN2016/082820, filed on May 20, 2016.

(30) Foreign Application Priority Data
Nov. 17, 2015 (CN) 201510792607.2

(51) Int. Cl. H04L 29/08; H04L 29/12; H04L 12/26

(52) U.S. Cl. CPC H04L 67/1008; H04L 43/0852; H04L 61/103; H04L 67/2847

(57) ABSTRACT

Disclosed are a method and an apparatus for selecting a source server. The method includes: judging whether an available source server exists; if one available source server exists, feeding a server address corresponding to the source server back to a cache server; and if multiple available source servers exist, feeding a server address corresponding to the source server with the fastest response back to the cache server. The present disclosure is mainly used in a content distribution network.

### CROSS REFERENCE TO RELATED APPLICATIONS

This application is a continuation of International Application No. PCT/CN2016/082820, filed on May 20, 2016, which is based upon and claims priority to Chinese Patent Application No. 201510792607.2, filed on Nov. 17, 2015, the entire contents of which are incorporated herein by reference.

### TECHNICAL FIELD

The present disclosure relates to internet technologies, and more particularly, to a method and an apparatus for selecting a source server.

### BACKGROUND

A content server is configured to store content resources provided by a content provider, and a client can acquire required content resources by sending a Hypertext Transfer Protocol (HTTP) request to the content server. For example, in a video playing scenario, a video server stores various video resources, when a user requests to play a certain video resource through an APP or webpage at a client, an HTTP connection is established between the client and the video server to send an HTTP request carrying a video resource ID to the video server. After receiving the HTTP request, the video server searches for corresponding video resource according to the video resource ID, and then returns the video resource to the client by means of an HTTP response.

In practical application, since a cardinal number of clients is very large, number of concurrent requests at the content server generally is higher. To reduce load pressure caused by a large number of HTTP requests on the content server and shorten waiting time for a client, in the prior art, an existing network architecture is improved, and a first level cache server is additionally disposed between the client and the content server so that content resources highly frequently requested by the client are cached in the cache server. When the client requests a certain content resource, an HTTP request is sent to the cache server. When a content resource requested by the client is stored in the cache server, the cache server directly returns the content resource to the client. When no content resource requested by the client is stored in the cache server, the cache server requests the content resource from the content server, then returns the content resource obtained by requesting to the client and stores the content resource in the cache server. After the cache server is additionally disposed, compared to an “intermediary” role of the cache server, the role of the content server is transformed into a source of resources providing original content resources. Therefore, in an improved network architecture, the content server is also referred to as a source server. As can be seen, presence of the cache server can greatly reduce number of HTTP requests at source servers and effectively reduce the load pressure for the source servers.

At present, the source servers in the foregoing network architecture generally are in a distributed deployment, namely, multiple homogeneous source servers are deployed on the cache server, where each source server stores complete and identical content resources. When no content resource is stored, the cache server can request resources from any source server. In a distributed system, different source servers may likely be deployed in different areas. Factors such as a distance between a source server and the cache server, transmission conditions, selection of operators and so on may affect response delay of the source server to the cache server. If the response delay of a source server is larger, request response speed at the client may be affected, and service quality in providing content resources may be reduced.

### SUMMARY

The present disclosure provides a method and an apparatus for selecting a source server, which can solve a problem that a client is slow in acquiring content resources.

To solve the foregoing problem, in a first aspect, embodiments of the present disclosure provide a method for selecting a source server, implemented by a client, including:

judging whether an available source server exists;

if one available source server exists, feeding a server address corresponding to the source server back to a cache server; and

if multiple available source servers exist, feeding a server address corresponding to the source server with the fastest response back to the cache server.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for selecting a source server mentioned by embodiments of the present disclosure.

In a third aspect, embodiments of the present disclosure provide a non-transitory computer-readable storage medium storing executable instructions that, when executed by an electronic device, cause the electronic device to perform any methods for selecting a source server mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for selecting a source server in accordance with some embodiments;

FIG. 2 is a flowchart of another method for selecting a source server in accordance with some embodiments;

FIG. 3 is a flowchart of another method for selecting a source server in accordance with some embodiments;

FIG. 4 is a flowchart of still another method for selecting a source server in accordance with some embodiments;

FIG. 5 is a block diagram showing composition of an apparatus for selecting a source server in accordance with some embodiments;

FIG. 6 is a block diagram showing composition of another apparatus for selecting a source server in accordance with some embodiments; and

FIG. 7 is a block diagram showing composition of an electronic device in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

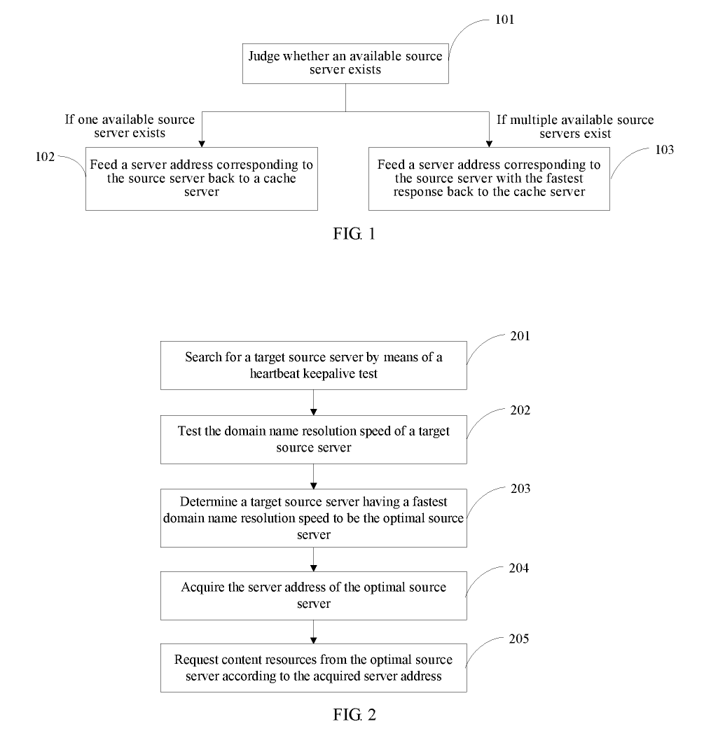

To solve the problem that a client is slow in request response speed, embodiments of the present disclosure provide a method and an apparatus for selecting a source server. As shown in FIG. 1, the method includes:

101: Judging whether an available source server exists.

The objective of this embodiment is to select an optimal source server between which and a cache server there is provided the fastest communication speed so that communication is implemented between the cache server and the optimal source server. Before the optimal source server is selected, first of all it is needed to determine which source servers are available, namely, target source servers are searched as to-be-selected objects. Multiple source servers can exist in a distributed system, a source server which can respond to the cache server can be selected therefrom as a target source server.

The so-called responding to the cache server refers that a source server is in a normal working state and can respond to an HTTP request from the cache server and return corresponding content resources to the cache server. In practical application, a keepalive test can be used to test a status of a source server.

102: If one available source server exists, feeding a server address corresponding to the source server back to a cache server.

When there is only one available source server, the server address of the source server can be directly returned to the cache server for use.

103: If multiple available source servers exist, feeding a server address corresponding to the source server with the fastest response back to the cache server.

When there are multiple target source servers, a response speed of each target source server is respectively tested. The so-called response speed refers to the communication speed between a target source server and the cache server. The communication speed is jointly affected by many factors including a processing capacity of a source server, a distance between the source server and the cache server, and transmission conditions, etc. In this embodiment, a result of the communication speed is verified by means of a test means without noticing specific factors affecting the communication speed.

In practical application, speed test can be carried out by simulating to send an HTTP request to a target source server, or communication speed of various intermediate nodes in a communication link, for example, a resolution speed of a domain name system (DNS) of the target source server is tested, this embodiment does not specifically limit a means for testing the communication speed. A test result of each target source server is obtained after a speed test is respectively performed on each target source server. According to test results, a target source server having the fastest communication speed is selected and determined to be the optimal source server. In one implementation of this embodiment, the server address of a source server is an Internet Protocol (IP) address. After the optimal source server is determined, the IP address of the optimal source server is returned to the cache server. The cache server takes the server address as a destination address of an HTTP request, and sends the HTTP request to the optimal source server to request corresponding content resources. When there is only one available source server, the cache server will request content resources from the available source server by means of the server address obtained in Step 102.

In practical application, the cache server can request content resources from a source server under (not limited to) following three cases: 1. no content resource requested by a client is stored at the cache server; 2. it is required to request a source server to update content resources when the content resources stored at the cache server are out of date; 3. content resources stored at the cache server are manually updated. This embodiment does not limit conditions of requesting by the cache server content resources from a source server.

FIG. 1 provides processes for selecting an optimal source server. In practical application, the processes as shown in FIG. 1 can be executed by a cache server or by a third device independent of the cache server and a source server. Subsequent embodiments of the present disclosure are described by taking the cache server as an executive body.

Further, as refinement of the method as shown in FIG. 1, an embodiment of the present disclosure further provides a method for selecting a source server. In the method, when multiple available source servers exist, the cache server may select the optimal source server by testing a domain name resolution speed. As shown in FIG. 2, the method includes:

201: Searching for a target source server by means of a heartbeat keepalive test.

First of all, the cache server needs to search for available target source servers. In this step, the cache server tests whether a source server is available by means of heartbeat keepalive method.

Specifically, the cache server can periodically (for example, once every five seconds) send a heartbeat packet to each source server. In a case that communication between the cache server and a source server is unavailable due to network link failure or in a case that a source server cannot respond to a heartbeat packet due to occurrence of failure although communication between the cache server and the source server is available, the cache server can judge whether the source server is available by determining whether a heartbeat response packet is received, namely, the source server is determined to be available if the heartbeat response packet can be received. In another case, when it is impossible to respond to an HTTP request because of higher load of a source server or other reasons although a network link is normal and the source server does not go wrong, the source server can return a heartbeat response packet to the cache server, where the heartbeat response packet carries status information indicating whether the source server is available. The cache server judges whether the source server is available according to the status information, namely, the source server is determined to be available when the status information indicates available.

Further, in another implementation of this embodiment, a source server can take the initiative to periodically send a heartbeat packet to the cache server. If the cache server cannot receive the heartbeat packet of a source server or a heartbeat packet can be received but status information in the heartbeat packet indicates unavailable, the cache server determines the source server to be unavailable.

When no available target source server is present, the cache server sends alarm information to the client or content provider and terminates execution of subsequent processes.

202: Testing the domain name resolution speed of a target source server.

In general, there are differences in domain name resolution speeds of DNS servers of different areas and different operators, and the same DNS server may have different speeds in resolving different domain names, and the speed of a DNS server in resolving the domain name of a source server may directly affect communication speed between the source server and the cache server. Therefore, in this embodiment, the domain name resolution speed of a DNS server can be tested.

In this step, the cache server is configured with a domain name of each source server in advance. The cache server respectively sends the domain name of each target source server to a DNS server for resolving and waits for a server address returned by the DNS server and obtained through domain name resolution.

203: Determining a target source server having a fastest domain name resolution speed to be the optimal source server.

A target source server corresponding to the domain name resolution response received at the earliest is determined by the cache server to be the optimal source server.

204: Acquiring the server address of the optimal source server.

The cache server acquires a server address from the domain name resolution response received at the earliest, where the server address is the server address of the optimal source server.

205: Requesting content resources from the optimal source server according to the acquired server address.

The cache server takes the acquired server address as a destination address of an HTTP request, adds a content ID of the content resource into the HTTP request and sends it to the optimal source server so that the optimal source server returns the content resource corresponding to the content ID. After obtaining the content resource, the cache server returns the content resource to the client by means of an HTTP response and saves the content resource locally. When the client requests the content resource next time, the cache server directly returns the content resource without requesting from the source server again.

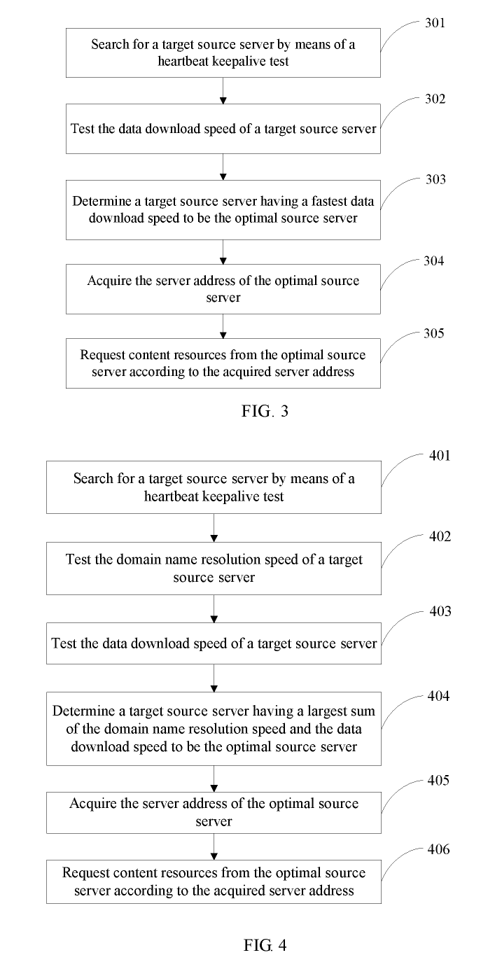

Further, as refinement of the method as shown in FIG. 1, an embodiment of the present disclosure further provides a method for selecting a source server. In the method, when multiple available source servers exist, the cache server may select the optimal source server by testing a data download speed. As shown in FIG. 3, the method includes:

301: Searching for a target source server by means of a heartbeat keepalive test.

An implementation of this step is the same as that of Step 201 in FIG. 2, and thus is not unnecessarily described herein.

302: Testing the data download speed of a source server.

The so-called testing the data download speed refers to a fact that the cache server makes an HTTP request from a target source server by simulating to request content resources, and tests time consumed from sending the HTTP request to receiving an HTTP response returned by the target source server. Since the request process in this step is merely for the purposes of test, there is no substantive meaning to request which content resource. Therefore, to save network transmission resources, particular data information having a smaller data size can be set as a content object of the HTTP request, for example, markup information of several bytes, which is not limited in this embodiment.

As previously mentioned, the cache server is configured with destination information for each source server. Before an HTTP request is initiated, the cache server sends a domain name to a DNS server for resolving to obtain a corresponding server address, and then the server address is taken as a destination address of the HTTP request so that the HTTP request is sent to different target source servers.

It should be explained that in a traditional site access process generally a site address needs to be obtained by means of domain name resolution. This embodiment is not involved with a test of the domain name resolution speed. However, as a necessary process for initiating an HTTP request, the cache server still needs to perform a domain name resolution on the DNS server to obtain the corresponding server address.

303: Determining a target source server having a fastest data download speed to be the optimal source server.

After sending an HTTP request to each target source server, the cache server waits for receiving HTTP responses, and determines a target source server corresponding to the HTTP response received at the earliest to be the optimal source server. The so-called target source server corresponding to the HTTP response received at the earliest refers to a target source server sending the HTTP response received at the earliest by the cache server. It is to be noted that the data download speed tested in this embodiment refers to time consumed from sending an HTTP request by the cache server to receiving an HTTP response. Affected by network transmission conditions, HTTP responses sent out earlier by a target source server may be not necessarily received by the cache server at the earliest. Therefore, the optimal source server in this embodiment refers to a target source server corresponding to the HTTP response received by the cache server at the earliest instead of a source server sending the HTTP response at the earliest among all target source server.

304: Acquiring the server address of the optimal source server.

Since the cache server resolves a server address corresponding to a domain name from a DNS server when the cache server sends an HTTP request, the cache server can search out a server address corresponding to the domain name of the optimal source server.

In addition, different from the embodiment in FIG. 2, when the cache server in this embodiment receives an HTTP response returned by the optimal source server, the cache server also can directly resolve a source address of the HTTP response, where the source address is the server address of the optimal source server.

305: Requesting content resources from the optimal source server according to the acquired server address.

An implementation of this step is the same as that of Step 205 in FIG. 2, and thus is not unnecessarily described herein.

Further, as refinement of the method as shown in FIG. 1, an embodiment of the present disclosure further provides a method for selecting a source server. In the method, when multiple available source servers exist, the cache server performs a comprehensive test on the domain name resolution speed and the data download speed to find out the source server having the fastest communication speed. As shown in FIG. 4, the method includes:

401: Searching for a target source server by means of a heartbeat keepalive test.

An implementation of this step is the same as that of Step 301 in FIG. 3, and thus is not unnecessarily described herein.

402: Testing the domain name resolution speed of a target source server.

First of all, the cache server sends a domain name of a target source server to a DNS server, after receiving a server address resolved by the DNS server according to the domain name, the cache server takes the address as a destination address of an HTTP request, and sends the HTTP request to the target source server.

The speed tested in Step 402 is a domain name resolution speed, namely, time consumed from sending domain name information by the cache server to the DNS server to receiving by the cache server the resolved server address. For ease of description, this period of time is denoted as T1 in this embodiment.

403: Testing the data download speed of a source server.

After obtaining the server address, the cache server sends an HTTP request to a target source server and computes time consumed from sending out the HTTP request to receiving the HTTP response, where this period of time is denoted as T2 in this embodiment.

404: Determining a target source server having a largest sum of the domain name resolution speed and the data download speed to be the optimal source server.

The sum of T1 and T2 is computed by the cache server to obtain total time denoted as T3 which reflects an overall communication speed of a source server. The cache server compares T3 of all target source servers, and determines a target source server corresponding to the minimum value to be the optimal source server.

Different from the processes in FIG. 2 or FIG. 3, when the communication speed of a source server is investigated in this embodiment, attention is not paid to time consumed in a certain link for domain name resolution or data downloading but to combination of both so as to reflect time consumed for initiating by the cache server a complete access process for a source server. In this embodiment, it does not represent that the communication speed of a target source server is the fastest when time consumed in a certain link is the shortest.

405: Acquiring the server address of the optimal source server.

Implementation of Step 204 in FIG. 2 or Step 304 in FIG. 3 can be referred to for implementation of this Step, which is not unnecessarily described herein.

406: Requesting content resources from the optimal source server according to the acquired server address.

An implementation of this step is the same as that of Step 305 in FIG. 3, and thus is not unnecessarily described herein.

Further, as a combination of the method as shown in FIG. 1 to FIG. 3, in one implementation of this embodiment, the cache server can periodically test the communication speed of a target source server. The communication speed of a target source server is comprehensively affected by various factors, and degree of impact of different factors on the communication speed in different periods may have occasionality. Therefore, periodically testing the communication speed of a target source server can more accurately and objectively reflect the real communication speed of the target source server within a period of time. Specifically, the cache server can test the domain name resolution speed and/or the data download speed of a target source server for many times according to a predetermined time interval, for example, testing once every day, every week or every month. The optimal source server is determined according to a tendency to change of historical test results. The so-called tendency to change of historical test results refers to tendency to change of the communication speed reflected by multiple test results within a period of time. In practical application, the cache server can draw a speed change curve for communication speed obtained by multiple tests directed at one target source server within a period of time, and a target source server corresponding to a curve whose curve shape is in an uptrend (namely, the communication speed is continuously improved) and whose curvilinear integral value is the maximum is determined to be the optimal source server. The curvilinear integral value is the area under the curve, the area can reflect the comprehensive level of the communication speed within the period of time. Of course, in practical application, an average value of the communication speed obtained in many times can be averaged to obtain a synthetic value of the communication speed.

The following provides two service scenarios of embodiments of the present disclosure, in the following service scenarios, a source server is tested and selected by the cache server. Specifically:

Scenario I is an operational scenario of a content distribution network (CDN).

The client initiates an HTTP request from the cache server, where the request carries a video ID of certain video resource that is needed to be acquired. After receiving the HTTP request, the cache server searches locally for video resources required for the client according to the video ID. When it is found that the video resources are not stored locally, the cache server requests the video resources from a source server. In this scenario, before requesting the video resources from a source server, the cache server first search for all available source servers from the CDN network, namely, target source servers. Afterward, the communication speed of each target source server is respectively tested. When the optimal source server having the fastest communication speed is found out, the cache server sends an HTTP request to the server address of the optimal source server, where the video ID of video resources required for the client is added into the request. After the video resources returned by the optimal source server through an HTTP response are received, the cache server stores the video resources locally, and responds to the HTTP request initiated by the client so that the video resources are returned to the client.

Scenario II is a test scenario of a source server in the CDN network.

In the CDN network, a content provider generally has its own source server. When a content distributor plays a role in connecting platforms of numerous content providers, sometimes it is required to test the communication speed of a source server at the request of a content provider. In this scenario, the target source servers determined by the cache server can be all source servers of the whole network or source servers of a certain content provider. The cache server respectively tests the communication speed of each target source server, and then reports a test result of the optimal source server to a corresponding content provider. Of course, all test results of all target source servers are reported. It should be explained that this scenario aims at testing a source server, and is not necessarily involved with actual requests of content resources. Therefore, compared with Scenario I, in this scenario it is unnecessary to execute the step of requesting content resources from the optimal source server.

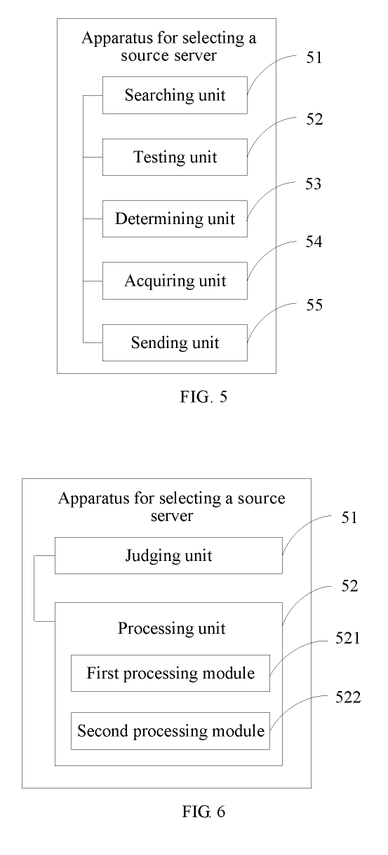

Further, as implementation of the foregoing method as shown in FIGS. 1-4, an embodiment of the present disclosure further provides an apparatus for selecting a source server. The apparatus can be deployed in a cache server, or can be independent of the cache server but a data interaction is maintained between the apparatus and the cache server so as to implement the foregoing method as shown in FIGS. 1-4. As shown in FIG. 5, the apparatus includes: a judging unit 51 and a processing unit 52, where

the judging unit 51 is configured to judge whether an available source server exists.

The objective of this embodiment is to select an optimal source server between which and a cache server there is provided the fastest communication speed so that communication is implemented between the cache server and the optimal source server. Before the optimal source server is selected, first of all it is needed to determine which source servers are available, namely, target source servers are searched as to-be-selected objects. Multiple source servers can exist in a distributed system, a source server which can respond to the cache server can be selected therefrom as a target source server.

The so-called responding to the cache server refers that the source server is in a normal working state and can respond to an HTTP request from the cache server and return corresponding content resources to the cache server. In practical application, a keepalive test means can be used to test a status of a source server.

The processing unit 52 is configured to feed, if one available source server exists, a server address corresponding to the source server back to a cache server, or feed, if multiple available source servers exist, a server address corresponding to the source server with the fastest response back to the cache server.

When there is only one available source server, there is no room for selecting the optimal source server, and the server address of the source server can be directly returned to the cache server for use.

When there are multiple target source servers, a response speed of each target source server is respectively tested. The so-called response speed refers to the communication speed between the target source server and the cache server. The communication speed is jointly affected by many factors including a processing capacity of the source server, a distance between the source server and the cache server, and transmission conditions, etc. In this embodiment, a result of the communication speed is verified by means of a test means without noticing specific factors affecting the communication speed.

Further, the processing unit 52 is configured to:

determine the source server with the fastest response according to a domain name resolution speed and/or a data download speed of a source server.

Further, as shown in FIG. 6, the processing unit 52 includes a first processing module 521 configured to:

test the domain name resolution speed of a source server; and

determine a source server having a fastest domain name resolution speed to be the source server with the fastest response.

In this embodiment, a domain name of each source server is configured in advance, the domain name of each target source server is respectively sent to a DNS server for resolving, and a server address returned by the DNS server and obtained through domain name resolution is waited for. A target source server corresponding to the domain name resolution response received at the earliest is determined to be the optimal source server.

Further, as shown in FIG. 6, the processing unit 52 includes a second processing module 522 configured to:

test the data download speed of a source server; and

determine a source server having a fastest data download speed to be the source server with the fastest response.

Domain name information of each source server is configured in this embodiment. After an HTTP request is initiated, a domain name is sent to a DNS server for resolving to obtain a corresponding server address, and then the server address is taken as a destination address of the HTTP request so that the HTTP request is sent to different target source servers.

It should be explained that in a traditional site access process generally a site address needs to be obtained by means of domain name resolution. This embodiment is not involved with a test of the domain name resolution speed. However, as a necessary process for initiating an HTTP request, it is still needed to perform a domain name resolution on the DNS server to obtain the corresponding server address.

Further, the processing unit 52 is configured to:

select and feed a server address corresponding to the source server with the fastest response back to a cache server so that the cache server requests content resources from the source server with the fastest response according to the server address.

The cache server takes the acquired server address as a destination address of an HTTP request, adds a content ID of the content resource into the HTTP request and sends it to the optimal source server so that the optimal source server returns content resource corresponding to the content ID. After obtaining the content resource, the cache server returns the content resource to the client by means of an HTTP response and saves the content resource locally. When the client requests the content resource next time, the cache server directly returns the content resource without requesting again from the source server.

Further, the judging unit 51 is configured to:

judge whether an available source server exists according to a heartbeat keepalive test.

In this embodiment a heartbeat packet can be periodically (for example, once every five seconds) sent to each source server. A source server is determined to be available if a heartbeat response packet can be received. Alternatively, it is judged whether a source server is available according to the status information, namely, the source server is determined to be available when the status information indicates available.

Further, the processing unit 52 is configured to:

periodically test the domain name resolution speed and/or the data download speed of a source server; and

determine the source server with the fastest response according to a tendency to change of historical test results.

The communication speed of a target source server is comprehensively affected by various factors, and degree of impact of different factors on the communication speed in different periods may have occasionality. Therefore, periodically testing the communication speed of a target source server can more accurately and objectively reflect the real communication speed of the target source server within a period of time. Specifically, the domain name resolution speed and/or the data download speed of a target source server can be tested for many times according to a predetermined time interval, for example, testing once every day, every week or every month. The optimal source server is determined according to a tendency to change of historical test results. The so-called tendency to change of historical test results refers to tendency to change of the communication speed reflected by multiple test results within a period of time.

The apparatus for selecting a source server provided by this embodiment can search for an optimal source server having the fastest communication speed from available target source servers, and return the server address of the optimal source server to a cache server so that the cache server requests content resources from the optimal source server. Compared with the prior art in which a cache server requests content resources from any source server, this embodiment can minimize a response delay between a cache server and a source server, thereby improving a request response speed for a client.

Further, an embodiment of the present disclosure further provides a non-transitory computer-readable storage medium storing executable instructions, which can be executed by an electronic device to perform any methods for selecting a source server mentioned by embodiments of the present disclosure.

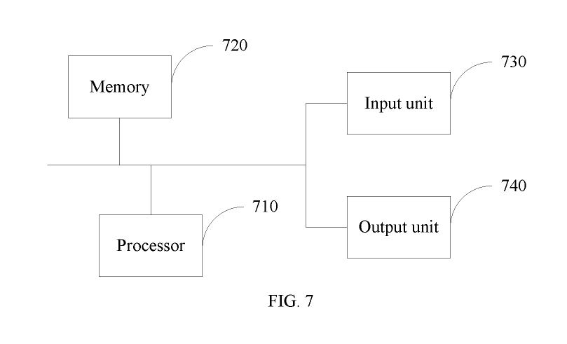

FIG. 7 is a block diagram of an electronic device which is configured to perform the methods for selecting a source server according to an embodiment of the present disclosure. As shown in FIG. 7, the device includes: one or more processors 710 and memory 720. A processor 710 is showed in FIG. 7 for an example.

Device which is configured to perform the methods for selecting a source server can also include: input unit 730 and output unit 740.

Processor 710, memory 720, input unit 730 and output unit 740 can be connected by BUS or other methods, and BUS connecting is showed in FIG. 7 for an example.

Memory 720 can be used for storing non-transitory software program, non-transitory computer executable program and modules as a non-transitory computer-readable storage medium, such as corresponding program instructions/modules for the methods for selecting a source server mentioned by embodiments of the present disclosure (such as shown in FIG. 6, judging unit 51, processing unit 52). Processor 710 performs kinds of functions and data processing of the electronic device by executing non-transitory software program, instructions and modules which are stored in memory 720, thereby realizes the methods for selecting a source server mentioned by embodiments of the present disclosure.

Memory 720 can include program storage area and data storage area, thereby the operating system and applications required by at least one function can be stored in program storage area and data created by using the device for selecting a source server can be stored in data storage area. Furthermore, memory 720 can include high speed Random-access memory (RAM) or non-volatile memory such as magnetic disk storage device, flash memory device or other non-volatile solid state storage devices. In some embodiments, memory 720 can include long-distance setup memories relative to processor 710, which can communicate with the device for selecting a source server by networks. The examples of said networks are including but not limited to Internet, Intranet, LAN, mobile Internet and their combinations.

Input unit 730 can be used to receive inputted number, character information and key signals causing user configures and function controls of the device for selecting a source server. Output unit 740 can include a display screen or a display device.

The said module or modules are stored in memory 720 and perform the methods for selecting a source server when executed by one or more processors 710.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The apparatus embodiments set forth above is merely exemplary, where units described as detached parts can be or not be detachable physically; parts displayed as units can be or not be physical units, i.e., either located at the same place, or distributed on a plurality of network units. Modules may be selected in part or in whole according to actual needs to achieve objectives of the solution of this embodiment. Those of ordinary skill in the art may comprehend and implement the embodiment without contributing creative effort.

It can be known from the foregoing implementations, those skilled in the art may clearly know that various implementations can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (personal computers or servers, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for selecting a source server, implemented by a client, comprising:
judging whether an available source server exists;
if one available source server exists, feeding a server address corresponding to the source server back to a cache server; and
if multiple available source servers exist, feeding a server address corresponding to the source server with the fastest response back to the cache server.

2. The method according to claim 1, comprising:
determining the source server with the fastest response according to a domain name resolution speed and/or a data download speed of a source server.

3. The method according to claim 2, comprising:
testing the domain name resolution speed of a source server; and
determining a source server having a fastest domain name resolution speed to be the source server with the fastest response.

4. The method according to claim 2, comprising:
testing the data download speed of a source server; and
determining a source server having a fastest data download speed to be the source server with the fastest response.

5. The method according to claim 4, comprising:
selecting and feeding a server address corresponding to the source server with the fastest response back to a cache server so that the cache server requests content resources from the source server with the fastest response according to the server address.

6. The method according to claim 3, comprising:
selecting and feeding a server address corresponding to the source server with the fastest response back to a cache server so that the cache server requests content resources from the source server with the fastest response according to the server address.

7. The method according to claim 2, comprising:
periodically testing the domain name resolution speed and/or the data download speed of a source server; and
determining the source server with the fastest response according to a tendency to change of historical test results.

8. An electronic device, comprising:
at least one processor; and
a memory communicably connected with the at least one processor for storing instructions executable by the at least one processor, wherein execution of the instructions by the at least one processor causes the at least one processor to:
judge whether an available source server exists; and
feed, if one available source server exists, a server address corresponding to the source server back to a cache server, or feed, if multiple available source servers exist, a server address corresponding to the source server with the fastest response back to the cache server.

9. The electronic device according to claim 8, wherein the instructions are executed to cause the at least one processor to:
determine the source server with the fastest response according to a domain name resolution speed or a data download speed of a source server.

10. The electronic device according to claim 9, wherein the instructions are executed to cause the at least one processor to:
test the domain name resolution speed of a source server, and determine a source server having a fastest domain name resolution speed to be the source server with the fastest response.

11. The electronic device according to claim 9, wherein the instructions are executed to cause the at least one processor to:
test the data download speed of a source server, and determine a source server having a fastest data download speed to be the source server with the fastest response.

12. The electronic device according to claim 11, wherein the instructions are executed to cause the at least one processor to:
select and feed a server address corresponding to the source server with the fastest response back to a cache server so that the cache server requests content resources from the source server with the fastest response according to the server address.

13. The electronic device according to claim 10, wherein the instructions are executed to cause the at least one processor to:
select and feed a server address corresponding to the source server with the fastest response back to a cache server so that the cache server requests content resources from the source server with the fastest response according to the server address.

14. The electronic device according to claim 9, wherein the instructions are executed to cause the at least one processor to:
periodically test the domain name resolution speed or the data download speed of a source server, and determine the source server with the fastest response according to a tendency to change of historical test results.

15. A non-transitory computer-readable storage medium storing executable instructions that, when executed by an electronic device, cause the electronic device to:
judge whether an available source server exists; and
feed, if one available source server exists, a server address corresponding to the source server back to a cache server, or feed, if multiple available source servers exist, a server address corresponding to the source server with the fastest response back to the cache server.

16. A non-transitory computer-readable storage medium according to claim 15, wherein the executable instructions are executed to cause the electronic device to:
determine the source server with the fastest response according to a domain name resolution speed or a data download speed of a source server.

17. A non-transitory computer-readable storage medium according to claim 16, wherein the executable instructions are executed to cause the electronic device to:
test the domain name resolution speed of a source server, and determine a source server having a fastest domain name resolution speed to be the source server with the fastest response.

18. A non-transitory computer-readable storage medium according to claim 16, wherein the executable instructions are executed to cause the electronic device to:
test the data download speed of a source server, and determine a source server having a fastest data download speed to be the source server with the fastest response.

19. A non-transitory computer-readable storage medium according to claim 18, wherein the executable instructions are executed to cause the electronic device to:
select and feed a server address corresponding to the source server with the fastest response back to a cache server so that the cache server requests content resources from the source server with the fastest response according to the server address.

20. A non-transitory computer-readable storage medium according to claim 17, wherein the executable instructions are executed to cause the electronic device to:
select and feed a server address corresponding to the source server with the fastest response back to a cache server so that the cache server requests content resources from the source server with the fastest response according to the server address.
